(19) United States
(12) Patent Application Publication
(10) Pub. No.: US 2025/0215303 A1
(43) Pub. Date: Jul. 3, 2025

(54) EPOXY-BASED COMPOSITION FOR THERMAL INTERFACE MATERIALS

(71) Applicant: Henkel AG & Co. KGaA, Duesseldorf (DE)

(72) Inventors: John Timmerman, Minneapolis, MN (US); Nicholas T. Kamar, Trenton, MI (US); Syed Z. Mahdi, Madison Heights, MI (US); Gage Badeau, Ham Lake, MN (US)

(21) Appl. No.: 19/050,013

(22) Filed: Feb. 10, 2025

Related U.S. Application Data
(63) Continuation of application No. PCT/US2023/029965, filed on Aug. 10, 2023.
(60) Provisional application No. 63/396,923, filed on Aug. 10, 2022.

(51) Int. Cl. C09K 5/14; C08G 59/22; C08G 59/24; C08G 59/38; C08G 59/52; C08K 3/22; H01M 10/613; H01M 10/653; H01M 10/6551

(52) U.S. Cl. CPC C09K 5/14; C08G 59/223; C08G 59/226; C08G 59/245; C08G 59/38; C08G 59/52; C08K 3/22; H01M 10/613; H01M 10/653; H01M 10/6551; C08K 2003/2227; C08K 2201/001

(57) ABSTRACT

A two-part thermally conductive curable composition exhibits high dispensing rates and cures to a thermally conductive interface material with high thermal reliability, including high fracture toughness and elongation properties. The curable composition employs a combination of multi-functional and mono-functional liquid epoxy resins with low viscosity.

### FIELD OF THE INVENTION

The present invention relates to thermally conductive compositions generally, and more particularly to two-part curable thermally conductive compositions for thermal interface materials that exhibit improved fracture toughness without reducing the dispensing rates of the curable compositions.

### BACKGROUND

Thermally conductive materials are widely employed as interfaces between, for example, a heat-generating electronic component and a heat dissipater for permitting transfer of excess thermal energy from the electronic component to a thermally coupled heat dissipater. Numerous designs and materials for such thermal interfaces have been implemented, with the highest performance being achieved when gaps between the thermal interface and the respective heat transfer surfaces are substantially avoided to promote conductive heat transfer from the electronic component to the heat dissipater. The thermal interface materials therefore preferably mechanically conform to the somewhat uneven heat transfer surfaces of the respective components. Important physical characteristics of high performance thermal interface materials are therefore flexibility and low modulus. In the case of dispensable materials, it is additionally important that the thermal interface is capable of wetting the heat transfer surface, and that it provides suitable adhesive and cohesive strength to avoid delamination and to maintain the form and function of the interface over the anticipated working lifetime. Dispensable thermal interface materials therefore may be designed with a yield stress to avoid significant spreading after dispensation, or without a yield stress to maximally flow and penetrate surfaces. Curing behavior of the material may also be tailored to both avoid particle settling and to provide sufficient pre-cure time for re-work and handling.

A particular application for thermally conductive materials that is finding increasing need is in automotive battery packs utilizing a plurality of distinct battery cells. The thermally conductive materials may adhesively connect adjacent cells in the pack, and/or may secure one or more heat dissipaters to the battery pack or to individual cells within the pack, while simultaneously providing a thermally conductive pathway to dissipate excess thermal energy from operating cells. Thus, the thermally conductive materials may perform both bonding and thermal management tasks.

Existing thermal interface materials based on epoxy resins are highly filled systems with relatively brittle mechanical and fracture behavior, and can perform poorly in automotive crash evaluations of battery pack systems. Alternative thermal interface materials commonly used in battery pack systems include filled polyurethanes. However, most useful polyurethanes exhibit relatively high pre-cure viscosities, which slows dispensing rates. Moreover, polyurethanes contain isocyanates, which pose health and safety challenges in manufacturing.

Two-part curable thermally conductive compositions have been widely used as thermal interface materials, potting compounds, adhesives and sealants in electronics, power, and automotive applications. Both parts of the curable compositions are kept in dispensable form in separate containers and pumped through hoses and mixing nozzles before they are applied onto substrates or injected to fill interstitial gaps. The material solidifies upon curing, and functions at least in part to dissipate heat from heat generating devices to cooling structures. For high throughput applications, the viscosity of the liquid phase in the curable compositions is preferably low to facilitate a high flow rate when pumped out of the container. However, conventional compositions typically require high particulate filler loading to establish satisfactory thermal conductivity properties, and use resin systems that exacerbate low dispensing rates due to high viscosities. High particulate filler loading leads to further embrittlement of epoxy materials. As a result, relatively low tensile elongation properties are observed in epoxy-based thermal interface materials.

Typically, the fracture toughness of epoxy resins is improved through the addition of polymeric toughening agents. However, incorporation of these high molecular weight (3,000-5,000+g/mol) toughening agents based on carboxyl terminated butadiene-acrylonitrile (CTBN), blocked polyurethane pre-polymer and pre-dispersed core shell rubber particle chemistries leads to undesired increases in the pre-cured composition viscosities, which undesirably decreases dispensing rates and correspondingly decreases manufacturing rates.

A need therefore exists for two-part curable thermally conductive epoxy compositions that are curable to thermal interface materials which exhibit improved material fracture toughness while maintaining high pre-cure dispensation rates. The thermal interface materials formed from such curable compositions should also exhibit good peel strength for adhesive qualities, increased tensile elongation for improved fracture toughness, and suitable lap shear strength and thermal reliability performance.

### SUMMARY

By means of the present invention, fracture toughness and other mechanical properties of highly thermally conductive adhesives/interface materials may be substantially improved without degradation of pre-cure dispensing rates. The epoxy resin systems of the present invention therefore preserve high throughput using standard two-part dispensing equipment while improving cured material reliability.

In one embodiment, a two-part curable composition for forming a thermally conductive interface material includes a first part with a first epoxy resin and a second epoxy resin that is different from the first epoxy resin. The second epoxy resin has an epoxy equivalent weight of at least 250, and the resin of the first part has a viscosity of no more than 5,000 cP at 25° C. and at a shear rate of 1 s⁻¹. The second part of the curable composition includes an amine curing agent that is effective to cure the first and second epoxy resins. The amine curing agent may have an amine equivalent weight of at least 80 g/eq, and a viscosity of no more than 5,000 cP at 25° C. and at a shear rate of 1 s⁻¹. The curable composition further includes thermally conductive filler in at least one of the first and second parts, wherein the cured thermally conductive interface material exhibits a thermal conductivity of at least 1.0 W/m*K.

The thermally conductive interface formed from the two-part curable composition exhibits a t-peel strength of at least 5 lb_{f}/in, a tensile elongation to break of at least 5%, and a lap shear strength of at least 350 psi.

The two-part curable composition may include between 50-95% by weight of the thermally conductive filler in each of the first and second parts. The thermally conductive filler may be selected from boron nitride, aluminum nitride, alumina, alumina trihydrate, silicon, silicon carbide, graphite, diamond, magnesium oxide, magnesium hydroxide, zinc oxide, and combinations thereof.

The first part of the two-part curable composition may include between 2-15% by weight of the first epoxy resin, and between 2-8% by weight of the second epoxy resin.

The first part of the two-part curable composition may include a monofunctional epoxy resin that is different from the first and second epoxy resins. In some embodiments, the second epoxy resin includes a tri-functional epoxy resin.

In some embodiments, the amine curing agent may include an alkane chain having at least 20 carbon atoms. The alkane chain of the amine curing agent may include at least 30 carbon atoms.

The epoxy equivalent weight of the second epoxy resin may at least 500.

In another embodiment, a two-part curable composition for forming a thermally conductive interface material includes a first part with a first epoxy resin having an epoxy equivalent weight of at least 250, and a second monofunctional epoxy resin that is different from the first epoxy resin. The first part has a resin viscosity of no more than 5,000 cP at 25° C. and at a shear rate of 1 s⁻¹. A second part of the two-part composition includes an amine curing agent that is effective to cure at least the first epoxy resin, and a viscosity of no more than 5,000 cP at 25° C. and at a shear rate of 1 s⁻¹. The two-part curable composition further includes thermally conductive filler in at least one of the first and second parts, wherein the cured thermally conductive interface material exhibits a thermal conductivity of at least 1.0 W/m*K.

The first epoxy resin in the first part may be multifunctional, and the first part may include a third epoxy resin that is different from each of the first and second epoxy resins, and is curable by the amine curing agent.

In some embodiments, the first part includes between 1 and 10% by weight of the first epoxy resin, between 1 and 10% by weight of the second epoxy resin, and between 1 and 30% by weight of the third epoxy resin.

At least one of the first and second parts of the two-part curable composition may include between 50 and 95% by weight of the thermally conductive filler.

In some embodiments, the monofunctional second epoxy resin includes an oxygen atom at a beta position.

In some embodiments, the amine curing agent is free from an ether group.

A battery system includes a battery cell, a heat dissipater, and a thermally conductive interface material disposed between the battery cell and the heat dissipater along a thermal dissipation pathway. The thermally conductive interface material may be curably formed from a two-part curable composition including a first part having a first epoxy resin with an epoxy equivalent weight of at least 250, and a second monofunctional epoxy resin that is different from the first epoxy resin. The two-part curable composition includes a second part with an amine curing agent that is effective to cure at least the first epoxy resin, and thermally conductive filler in at least one of the first and second parts in an amount sufficient so that the thermally conductive interface material exhibits a thermal conductivity along the thermal dissipation pathway of at least 1.0 W/m*K. The mixed two-part curable composition may exhibit a viscosity of no more than 500,000 cP at 25° C. and at a shear rate of 1 s⁻¹.

### BRIEF DESCRIPTION OF THE DRAWING

FIG. 1 is a schematic illustration of a battery system employing a thermally conductive interface material of the present invention.

### DETAILED DESCRIPTION

The objects and advantages enumerated above together with other objects, features, and advances represented by the present invention are now described in terms of detailed embodiments. Other embodiments and aspects of the invention, however, are recognized as being within the grasp of those having ordinary skill in the art.

The thermally conductive interface materials of the present invention may be formed as a coating on a surface, as a gap filler for placement along a thermal dissipation pathway, or a self-supporting body for placement along a thermal dissipation pathway, typically to remove excess heat from a heat-generating electronic component or battery system. The thermally conductive interface materials may exhibit adhesive properties to, for example, secure battery cells within a battery pack. The thermally conductive interface materials preferably exhibit a thermal conductivity of at least 1 W/m*K, and sufficient wettability to coat the respective surface prior to curing. The materials also preferably exhibit sufficient flexibility and cohesive strength to provide a stable interface, including one which is suitable to undergo automotive battery pack crash or other impact testing with minimal or no failure.

The thermally conductive interface material is formed from a two-part curable composition that is dispensable from at least two separate vessels in order to separate a first curable component from a curing agent that promotes a cure reaction to the first curable component in order form a matrix, such as a resin matrix. The first part, or curable component, includes a mixture of two or more distinct epoxy resins that are curable in the presence of the curing agent in the second part. Thermally conductive filler is included in at least one of the parts to provide the desired thermal conductivity characteristics.

One or both parts of the two-part curable composition may additionally contain rheology modifiers, compatibilizers, plasticizers, pigments, water scavengers, anti-oxidants, and other functional fillers.

### Resin Matrix Material

The thermally conductive interface materials of the present invention comprise a matrix formed from at least a curable resin component and a chemical curing agent. Preferably, a cure reaction is initiated with exposure between the curable resin component and the curing agent, in some cases when in the presence of an environmental cure reaction facilitator, such as water, heat, pressure, electromagnetic radiation, and the like.

The curable resin component may include a combination of epoxy resins that are curable into a resin matrix that exhibits surprisingly enhanced fracture toughness, peel strength, tensile elongation, and lap shear strength in comparison to conventional epoxies and epoxy blends. A wide variety of epoxy-functionalized resins are contemplated for use in the curable compositions of the present invention. For example, liquid-type epoxy resins based on bisphenol A, liquid-type epoxy resins based on bisphenol F, multifunctional epoxy resins based on phenol novolac resin, dicyclopentadiene-type epoxy resins, naphthalene-type epoxy resins, and the like. Other example epoxy-functionalized resins contemplated for use herein include the diepoxide of the cycloaliphatic alcohol, hydrogenated bisphenol A (commercially available as Epalloy 5000), a difunctional cycloaliphatic glycidyl ester of hexahydrophthalic anhydride (commercially available as Epalloy 5200), Epiclon EXA-835LV, Epiclon HP-7200L, and the like, as well as mixtures of any two or more thereof.

In some embodiments, the curable composition may include a combination of two or more different epoxy-functionalized resins, including two or more different bisphenol based epoxies. The bisphenol based epoxies may be selected from bisphenol A, bisphenol F, or bisphenol S epoxies, and combinations thereof. In addition, two or more different bisphenol epoxies within the same type of resin (such A, F, or S) may be used.

Commercially available examples of the bisphenol epoxies contemplated for use herein include bisphenol-F-type epoxies (such as RE-404-S from Nippon Kayaku, Japan, and EPICLON 830 (RE1801), 830S (RE1815), 830A (RE1826) and 830W from Dai Nippon Ink & Chemicals, Inc., and RSL 1738 and YL-983U from Resolution) and bisphenol-A-type epoxies (such as YL-979 and 980 from Resolution). Further examples of commercially available epoxy resins include Epon 828, Epon 826, Epon 862 (all from Hexion Co., Ltd.), DER 331, DER 383, DER 332, DER 330-EL, DER 331-EL, DER 354, DER 321, DER 324, DER 29, DER 353 (all from Dow Chemical Co.), JER YX8000, JER RXE21, JER YL 6753, JER YL6800, JER YL980, JER 825, and JER 630 (all from Japan Epoxy Resins Co).

The bisphenol epoxies available commercially from Dai Nippon and noted above are promoted as liquid undiluted epichlorohydrin-bisphenol F epoxies having much lower viscosities than conventional epoxies based on bisphenol A epoxies and have physical properties similar to liquid bisphenol A epoxies. Bisphenol F epoxy has lower viscosity than bisphenol A epoxies, all else being the same between the two types of epoxies, which affords a lower viscosity and thus a fast flow underfill sealant material. The Epoxy Equivalent Weight (EEW), which is the molecular weight divided by the number of epoxy groups of these four bisphenol F epoxies is between 165 and 180. The viscosity at 25° C. is between 3,000 and 4,500 cps (except for RE1801 whose upper viscosity limit is 4,000 cps). The hydrolyzable chloride content is reported as 200 ppm for RE1815 and 830W, and that for RE1826 as 100 ppm.

The bisphenol epoxies available commercially from Resolution and noted above are promoted as low chloride containing liquid epoxies. The bisphenol A epoxies have an EEW (g/eq) of between 180 and 195 and a viscosity at 25° C. of between 100 and 250 cP. The total chloride content for YL-979 is reported as between 500 and 700 ppm, and that for YL-980 as between 100 and 300 ppm. The bisphenol F epoxies have a EEW (g/eq) of between 165 and 180 and a viscosity at 25° C. of between 30 and 60. The total chloride content for RSL-1738 is reported as between 500 and 700 ppm, and that for YL-983U as between 150 and 350 ppm.

In addition to the bisphenol epoxies, other epoxy compounds are contemplated for use as the epoxy component of invention formulations. For instance, cycloaliphatic epoxies, such as 3,4-epoxycyclohexylmethyl-3,4-epoxycyclohexylcarbonate, can be used. Also monofunctional, difunctional or multifunctional reactive diluents may be used to adjust the viscosity and/or lower the glass transition temperature (Tg) of the resulting resin material. Exemplary reactive diluents include butyl glycidyl ether, cresyl glycidyl ether, o-cresyl glycidyl ether, polyethylene glycol glycidyl ether, polypropylene glycol glycidyl ether, and the like.

Other epoxies suitable for use herein include polyglycidyl derivatives of phenolic compounds, such as those available commercially under the tradename EPON, such as EPON 828, EPON 1001, EPON 1009, and EPON 1031 from Resolution; DER 331, DER 332, DER 334, and DER 542 from Dow Chemical Co.; and BREN-S from Nippon Kayaku. Other suitable epoxies include polyepoxides prepared from polyols and the like and polyglycidyl derivatives of phenol-formaldehyde novolacs, the latter of such as DEN 431, DEN 438, and DEN 439 from Dow Chemical. Cresol analogs are also available commercially under the tradename ARALDITE, such as ARALDITE ECN 1235, ARALDITE ECN 1273, and ARALDITE ECN 1299 from Ciba Specialty Chemicals Corporation. SU-8 is a bisphenol-A-type epoxy novolac available from Resolution. Polyglycidyl adducts of amines, aminoalcohols and polycarboxylic acids are also useful in this invention, commercially available resins of which include GLYAMINE 135, GLYAMINE 125, and GLYAMINE 115 from F.I.C. Corporation; ARALDITE MY-720, ARALDITE 0500, and ARALDITE 0510 from Ciba Specialty Chemicals and PGA-X and PGA-C from the Sherwin-Williams Co.

The epoxy resin component of the curable composition may preferably be in a liquid state and contained in one part of a two-part composition. The epoxy resin may exhibit a viscosity of no greater than 5,000 cP at 25° C. and at a shear rate of 1 s⁻¹, in some embodiments a viscosity of no greater than 2,000 cP at 25° C. and at a shear rate of 1 s⁻¹, in some embodiments a viscosity of no greater than 1,000 cP at 25° C. and at a shear rate of 1 s⁻¹, and in some embodiments a viscosity of no greater than 500 cP at 25° C. and at a shear rate of 1 s⁻¹. In some embodiments the part of the composition that contains the epoxy resin component exhibits the viscosity parameters described above. Even when blended with thermally conductive particles, the curable composition exhibits relatively low viscosity levels that facilitate high dispensing rates through conventional 2-part curable resin dispensing systems.

In some embodiments, the epoxy resin component includes an epoxy resin having an EEW of at least 100. In some embodiments, the epoxy resin component includes an epoxy resin having an EEW of at least 250. In some embodiments, the epoxy resin component includes an epoxy resin having an EEW of at least 500. In some embodiments, the epoxy resins having an EEW of at least 100, at least 250, or at least 500, may be difunctional, trifunctional, or other polyfunctional epoxy resins. In one embodiment, the epoxy resin component includes a trifunctional epoxy resin having an EEW of at least 500. An example of such a polyepoxide resin is 9-octadecenoic acid, 12-(2-oxiranylmethoxy)-1,2,3-propanetriyl ester homopolymer. Preferably, the epoxy resin having an EEW of at least 100, at least 250, or at least 500, exhibits a relatively low pre-cure viscosity in order to facilitate an epoxy resin component of low viscosity.

The epoxy resin component of the curable composition may further include a monofunctional epoxy resin. It has been surprisingly discovered that such a monoepoxide resin leads to improved retention of cured material properties as a function of time, possibly due to reaction with otherwise unreacted 2′ and even 3′ amines to limit further changes in cross-link density and/or network properties after onset of gelation. The monoepoxide resin may further react with available-OH groups on the epoxy backbone. Moreover, an improvement in thermal reliability is surprisingly observed with the addition of a monoepoxide resin, at least within certain loading concentrations relative to other epoxy resins.

Example monoepoxide resins include monoglycidyl ethers, such as phenyl glycidyl ether, alkyl phenol monoglycidyl ether, aliphatic monoglycidyl ether, alkyphenol mono glycidyl ether, alkylphenol monoglycidyl ether, 3-glycidoxypropyl trimethoxysilane, 3-glycidoxypropyl trimethoxysilane, 3-glycidoxypropylmethyldimethoxysilane, and o-cresyl glycidyl ether.

In some embodiments, the monofunctional epoxy resins may have an epoxy group with an alkyl group of about 6 to about 28 carbon atoms, examples of which include C₆₋₂₈ alkyl glycidyl ethers, C₆₋₂₈ fatty acid glycidyl ethers, C₆₋₂₈ alkylphenol glycidyl ethers, and the like. In some embodiments, the monofunctional epoxy resins may have an oxygen atom at the beta position.

The matrices formed from the curable component and the curing agent of the present invention comprise in the range of about 0.01 up to about 50 percent by weight of the total composition, preferably in the range of about 0.1 up to about 50 percent by weight of the total composition, preferably in the range of about 0.5 up to about 50 percent by weight of the total composition, and preferably in the range of about 1 up to about 50 percent by weight of the total composition. In some embodiments, the matrices formed from the curable component and the curing agent of the present invention comprise in the range of 5 up to about 50 percent by weight of the total composition, and more preferably in the range of 10 up to about 50 percent by weight of the total composition.

The curable component is preferably an epoxy resin component comprising one or more epoxy resins. In some embodiments, the epoxy resin component comprises two or more epoxy resins that are different from one another. In some embodiments, the epoxy resin component is or is a portion of a first part in a two-part curable composition. The first part may include constituents other than epoxy resins. The epoxy resins of the first part may be curable with exposure to a curing agent in a second part of the two-part curable composition.

In some embodiments, epoxy resins in the first part may comprise between 1 and 50 percent by weight of the first part. In some embodiments, epoxy resins in the first part may comprise between 5 and 50 percent by weight of the first part. In some embodiments, epoxy resins in the first part may comprise between 10 and 50 percent by weight of the first part. In some embodiments, epoxy resins in the first part may comprise between 12 and 50 percent by weight of the first part. In some embodiments, the epoxy resins in the first part may comprise between 1 and 40 percent by weight of the first part. In some embodiments, epoxy resins in the first part may comprise between 5 and 40 percent by weight of the first part. In some embodiments, the epoxy resins in the first part may comprise between 10 and 40 percent by weight of the first part. In some embodiments, the epoxy resins in the first part may comprise between 12 and 40 percent by weight of the first part. In some embodiments, the epoxy resins in the first part may comprise between 1 and 30 percent by weigh of the first part. In some embodiments, the epoxy resins in the first part may comprise between 5 and 30 percent by weight of the first part. In some embodiments, the epoxy resins in the first part may comprise between 10 and 30 percent by weight of the first part. In some embodiments, the epoxy resins in the first part may comprise between 12 and 30 percent by weight of the first part.

One or more polyfunctional epoxy resins in the first part may comprise between 1 and 40 percent by weight of the first part. In some embodiments, the one or more polyfunctional epoxy resins in the first part may comprise between 2 and 35 percent by weight of the first part. In some embodiments, the one or more polyfunctional epoxy resins in the first part may comprise between 5 and 30 percent by weight of the first part. A first polyfunctional epoxy resin may comprise between 2 and 15 percent by weight of the first part, and in some embodiments between 2 and 8 percent by weight of the first part. A second polyfunctional epoxy resin may comprise between 2 and 15 percent by weight of the first part, and in some embodiments between 2 and 8 percent by weight of the first part. A third polyfunctional epoxy resin may comprise between 2 and 15 percent by weight of the first part, and in some embodiments between 2 and 8 percent by weight of the first part. At least one of the polyfunctional epoxy resins may be a trifunctional epoxy resin.

In some embodiments, one or more monofunctional epoxy resins in the first part may comprise between 1 and 10 percent by weight of the first part. In some embodiments, the one or more monofunctional epoxy resins in the first part may comprise between 2 and 8 percent by weight of the first part. In some embodiments, the one or more monofunctional epoxy resins in the first part may comprise between 2 and 5 percent by weight of the first part.

### Amine Curing Agent

The second part of the two-part curable compositions of the present invention includes an amine curing component having one or more amine curing agents, at least one of which is preferably effective to cure epoxy resins in the first part of the curable composition. In some embodiments, the amine curing agent is effective to cure each of the epoxy resins in the first part of the curable composition. For the purposes hereof, the term “cure” is intended to mean a cross-linking reaction to form a tri-dimensional polymer network. In some embodiments, the amine curing agent is provided in sufficient quantity to cause the liquid parts of the two-part curable composition to solidify, at least to or through a gel condition.

Amine curing agents to cure epoxy resins are well known. However, it has been discovered that certain amine curing agents may provide improved T-peel strength and tensile elongation properties of the cured material. In particular, the amine curing agent may include a branched or unbranched alkane chain having at least 20 carbon atoms, and preferably at least 30 carbon atoms. In addition, the amine curing agent may be free of ether groups. In some embodiments, the amine curing agent may be hydrophobic. The amine curing agent may have an amine hydrogen equivalent weight (“AHEW”) of at least 50 g/eq, and in some embodiments at least 80 g/eq, and in some embodiments at least 100 g/eg. An example amine curing agent may be prepared by a polymerization reaction of a dimerized fatty acid with a polyamine, wherein the dimer acid has between 4 and 60 carbon atoms, preferably at least 20 carbon atoms, preferably at least 30 carbon atoms, and in some embodiments 36 carbon atoms. A C₃₆ dimer diamine is an example amine curing agent useful in the curable compositions of the present invention.

In some embodiments, the amine curing agent may be present in the second part of the two-part curable compositions in a range of between 1 and 30 percent by weight of the second part. In some embodiments, the amine curing agent may be present in the second part in a range of between 5 and 25 percent by weight of the second part. In some embodiments, the amine curing agent may be present in the second part in a range of between 10 and 20 percent by weight of the second part. In some embodiments, the amine curing agent may be present in the second part in a range of between 10 and 15 percent by weight of the second part.

The second part of the curable composition, apart from thermally conductive particles, may preferably be in a liquid state which exhibits a viscosity of no greater than 5,000 cP at 25° C. and at a shear rate of 1 s⁻¹, in some embodiments a viscosity of no greater than 2,000 cP at 25° C. and at a shear rate of 1 s⁻¹, in some embodiments a viscosity of no greater than 1,000 cP at 25° C. and at a shear rate of 1 s⁻¹, and in some embodiments a viscosity of no greater than 500 cP at 25° C. and at a shear rate of 1 s⁻¹. In some embodiments, the part of the curable composition that contains the amine curing agent and the composition exhibits the viscosity parameters described above. Even when blended with thermally conductive particles, the curable composition exhibits relatively low viscosity levels that facilitate high dispensing rates through conventional 2-part curable resin dispensing systems.

In some embodiments, the ratio of amine equivalent in the second part to the epoxy equivalent in the first part, or, more generally, the ratio of amine equivalent to the epoxy equivalent in the curable compositions of the present invention may be between 0.7 and 1.2 to achieve desired physical properties of the cured material. In some embodiments, the ratio of amine equivalent to epoxy equivalent in the curable compositions of the present invention may be between 0.8 and 1.2. In some embodiments, the first part and the second part of the curable compositions are blended for the cure reaction in a ratio of (first part: second part) between 0.8 and 1.2 by weight.

### Thermally Conductive Filler

The curable compositions of the present invention include at least one thermally conductive filler in at least one of the first and second parts in order to provide suitable thermal conductivity to the cured material.

Conductive fillers contemplated for use herein include, for example, boron nitride, aluminum nitride, alumina, alumina trihydrate, silicon, silicon carbide, graphite, diamond, magnesium oxide, magnesium hydroxide, zinc oxide, gold, silver, copper, platinum, palladium, nickel, aluminum, indium, alloy of nickel (e.g., alloy 42), alloy of zinc, alloy of iron, alloy of indium, silver-plated copper, silver-plated aluminum, bismuth, tin, bismuth-tin alloy, silver-plated fiber, silver-plated graphite, silver-plated silicon carbide, silver-plated boron nitride, silver-plated diamond, silver-plated alumina, silver-plated alloy 42, graphene, silver-plated graphene, graphene nanoplatelets, single and multi-wall carbon nanotubes, silver-coated polymer, cadmium and alloys of cadmium, lead and alloys of lead, antimony and alloys of antimony, and the like, as well as mixtures of any two or more thereof. In some embodiments, the thermally conductive filler may be selected to be electrically conductive or electrically insulative. In some embodiments, the thermally conductive filler may be in particulate form with a particle size in the range of about 1 nm up to about 200 μm; in some embodiments, the conductive filler has a particle size in the range of about 10 nanometers up to about 20 micrometers.

In some embodiments, the particulate thermally conductive filler may be substantially spherical, plate-like, rod-like, or combinations thereof. The thermally conductive filler may be present in the range of between 50 and 95 percent by weight of the total composition. In some embodiments, the thermally conductive filler may be present in the range of between 60 and 95 percent by weight of the total composition. In some embodiments, the thermally conductive filler may be present in the range of between 70 and 90 percent by weight of the total composition.

The thermally conductive filler may be allocated to one or more parts of the curable composition, such that the cured thermally conductive interface material exhibits a thermal conductivity of at least 1.0 W/m*K, and more preferably at least 2.0 W/m*K. The mixed two parts of the curable composition, including the thermally conductive filler, may exhibit a viscosity of less than 500,000 cP at 25° C. and at a shear rate of 1 s⁻¹, in some embodiments a viscosity of less than 300,000 cP at 25° C. and at a shear rate of 1 s⁻¹, in some embodiments a viscosity of less than 200,000 cP at 25° C. and at a shear rate of 1 s⁻¹, in some embodiments a viscosity of less than 100,000 cP at 25° C. and at a shear rate of 1 s⁻¹, in some embodiments a viscosity of less than 50,000 cP at 25° C. and at a shear rate of 1 s⁻¹, and in some embodiments a viscosity of less than 10,000 cP at 25° C. and at a shear rate of 1 s⁻¹.

### Optional Additives

The second part of the two-part curable composition, including the curing agent, may include a curing accelerator to promote the curing of epoxy resin. The curing accelerator may be selected from tertiary amines, imidazole derivatives, and combinations thereof.

Example tertiary amines include trimethylamine, tri-ethlyamine, tetraethylmethylenediamine, tetramethylpropane-1,3-diamine, tetra-methylhexane-1,6-diamine, pentamethyldiethylenetriamine, bis(2-dimethylaminoethyl) ether, ethylene glycol (3-dimethyl)aminopropyl ether, dimethyl-aminoethanol, dimethylaminoethyoxyethanol, trietheylenediamine, and hexamethylenetriamine. In some embodiments, the curing accelerator may be present in an amount of between 0 and 1 percent by weight of the second part, and preferably between 0.1 and 0.6 percent by weight of the second part.

The two-part curable composition may also include a thixotropic agent in one or both of the first and second parts. Suitable thixotropic agents include talc, fumed silica, surface-treated calcium carbonate, fine particle alumina, plate-like alumina, montmorillonite, aluminum borate whisker, and the like. The thixotropic agent may be present in an amount of between 0 and 3 percent by weight, preferably between 0.2 and 2 percent by weight based on the total weight of the respective first or second part.

The composition may further comprise inorganic or organic pigments in one or both of the first and second parts, including ferric oxide, brick dust, carbon black, titanium oxide, and combinations thereof.

The composition may also include one or more flow additives, adhesion promoters, rheology modifiers, toughening agents, fluxing agents, film flexibilizers, phenol-novac hardeners, as well as mixtures of any two or more thereof.

As used herein, the term “flow additives” refers to compounds which modify the viscosity of the formulation to which they are introduced. Exemplary compounds which impart such properties include silicon polymers, ethyl acrylate/2-ethylhexyl acrylate copolymers, alkylol ammonium salts of phosphoric acid esters of ketoxime, and the like, as well as combinations of any two or more thereof.

As used herein, the term “adhesion promoters” refers to compounds which enhance the adhesive properties of the formulation to which they are introduced.

As used herein, the term “rheology modifiers” refers to additives which modify one or more physical properties of the formulation to which they are introduced.

As used herein, the term “toughening agents” refers to additives which enhance the impact resistance of the formulation to which they are introduced.

As used herein, the term “fluxing agents” refers to reducing agents which prevent oxides from forming on the surface of the molten metal.

As used herein, the term “film flexibilizers” refers to agents which impart flexibility to the films prepared from formulations containing same.

As used herein, the term “phenol-novolac hardeners” refers to materials which participate in the further interaction of reactive groups so as to increase the cross-linking thereof—thereby enhancing the stiffness thereof.

A further aspect of the present invention relates to a method for preparing a thermally conductive interface material adhered to a substrate of an assembly. A two-part curable composition as described above is prepared, and the first and second parts are mixed to form a reaction mixture. In some embodiments, the first and second parts are mixed at less than 100° C., in some embodiments less than 70° C., in some embodiments less than 60° C., and in some embodiments at about 25° C. The reaction mixture is then applied to at least one surface of the substrate.

The first and second parts of the two-part curable composition are kept separated from each other and the mixing is carried out prior to immediate use, after applying the mixture to the parts to allow for the mixture to cure. In some embodiments, the mixture is cured at an elevated temperature, such as between 6° and 100° C. for between 30 and 240 minutes. In some embodiments, the mixture is cured at an elevated temperature of between 8° and 90° C. for between 30 and 90 minutes.

The reaction mixture may be applied to the substrate in any convenient technique. Typically, the composition is applied to one surface of a pair of substrates, and then the substrates are brought into registration to be bonded by the thermally conductive interface material.

It is an aspect of the present invention that the cured thermally conductive interface material exhibits improved mechanical properties, including a bonding strength of more than 10 MPa with 100% cohesive failure mode on an aluminum substrate. The cured thermally conductive interface material further exhibits a t-peel strength, as measured by ASTM D1876, of at least 2 lb_{f}/in, preferably at least 5 lb_{f}/in, and in some embodiments at least 6 lb_{f}/in. The cured thermally conductive interface material may also exhibit a tensile elongation to break, as measured by ASTM D638, of at least 2%, preferably at least 5%, and in some embodiments at least 7%. The cured thermally conductive interface material may further exhibit a lap shear strength, as measured by ASTM D1002, of at least 350 psi, preferably at least 500 psi, and in some embodiments at least 600 psi.

The curable compositions of the present invention have been found to form a thermally conductive interface material that surprisingly exhibits significantly higher fracture toughness than conventional thermally conductive epoxy adhesive systems, while maintaining high dispensing rates and high thermal conductivity.

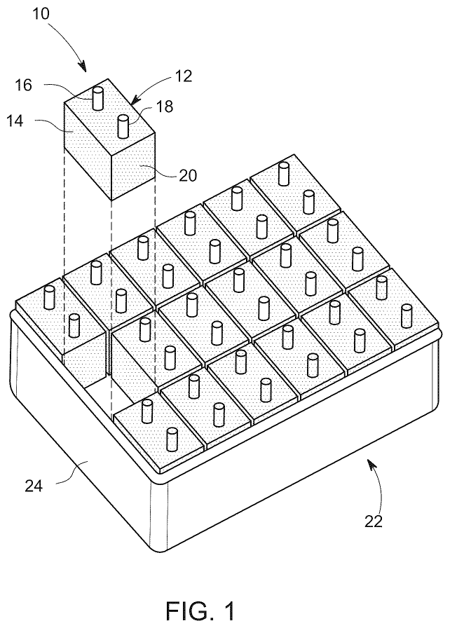

A further aspect of the present invention relates to the use of the two-part curable composition in bonding battery pack modules of electronic automotive battery systems. FIG. 1 illustrates a battery system 10 including a battery cell 12 having a case 14 and first and second terminals 16, 18. Battery cell 12 may be any of a variety of battery types, wherein a need for a thermally conductive interface 20 is identified. A particular embodiment of battery system 10 may employ lithium ion-type battery cells 12, which may be assembled into a battery module 22 of a plurality of battery cells 12, as well as in a battery pack (not shown), and between respective parts of a container for a plurality of battery modules 22. Thermally conductive interface 20 is preferably applied along a heat dissipation pathway between the battery cells 12, the battery module 22, and one or more heat dissipating elements.

### Examples

The following examples are intended to assist one skilled in the art to better understand and practice the present invention. The scope of the invention is not limited by the examples but is defined in the appended claims. All parts and percentages are based on weight unless otherwise stated.

### Raw Materials:

EPON-862 is a liquid diglycidyl ether of bisphenol F with an epoxy equivalent weight (EEW) of 165-173.
EPON-826 is a liquid diglycidyl ether of bisphenol A with an epoxy equivalent weight (EEW) of 178-186.
Heloxy 62 is a liquid monofunctional o-cresyl glycidyl ether with an epoxy equivalent weight (EEW) of 175-195.
Heloxy 505 is a liquid trifunctional epoxy resin of 9-octadecenoic acid, 12-(2-oxiranylmethoxy)-1,2,3-propanetriyl ester, homopolymer with an epoxy equivalent weight (EEW) of 500-650.
Cardolite NC-513 is a liquid glycidyl ether from cashew nutshells.
UTWFA240 is fused alumina.
TM2250 is surface treated alumina.
Lansco CB is carbon black pigment.
R974 is a hydrophobic fumed silica treated with dimethyl dichlorosilane
TLT 100LV is a reaction product of diglycidyl ether of bisphenol-A and a polyetheramine used as a toughening agent
Epikure 3251 is an amine curing agent of alkyl phenol, aliphatic amine, alkyletheramine, 4-nonyl phenol, alkyl amine
Priamine 1074 is an amine curing agent of C₃₆-dimer fatty acid, diamine hydrogenated

The following tables show Examples 1-9, with Example 1 representing a prior art formulation. The example compositions are mixed at a 1:1 ratio of part A and part B. Examples 2-9 show compositions having improved tensile elongation, T-peel strength, and failure mode on aluminum adherends, along with a thermal conductivity of 2.0 W/m*K. Furthermore, Example 9 shows a significant improvement in thermal reliability performance (resistance between a transistor and a heat sink) as compared to the control Comparative Example 1. It is noteworthy that conventional polyurethane resin-based adhesive systems often exhibit a dispense rate in the range of about 45 g/min at 90 psi.

The data shown in Table 1 indicates that modification of the Comparative Example 1 B-side via a direct replacement of the Mannich base type curative agent with a C₃₆-dimer fatty acid diamine leads to a 114.3% improvement in T-peel strength on 6061 aluminum (Al). This improvement is likely due to an improvement in surface wetting of the adhesive onto the aluminum surface and increased flexibility of the resultant cured epoxy network.

TABLE 1

| | | Comparative | | | |
|---|---|---|---|---|---|
| | | Example #1 | | Example #2 | |
| Ingredient | Density (g/ml) | wt. % | phr | wt. % | phr |
| Part A | | | | | |
| EPON 862 | 1.180 | 12.011 | 50.00 | 12.011 | 50.00 |
| EPON 826 | 1.160 | 12.011 | 50.00 | 12.011 | 50.00 |
| Fortegra 100 | 1.030 | 0.000 | 0.00 | 0.000 | 0.00 |
| Heloxy 505 | 1.020 | 0.000 | 0.00 | 0.000 | 0.00 |
| Heloxy 62 | 1.080 | 0.000 | 0.00 | 0.000 | 0.00 |
| Silquest A-187 | 0.980 | 0.000 | 0.00 | 0.000 | 0.00 |
| (GLYMO) | | | | | |
| Cardolite 513 | 0.970 | 0.000 | 0.00 | 0.000 | 0.00 |
| TLT 100LV | 1.000 | 0.000 | 0.00 | 0.000 | 0.00 |
| UTWFA240 | 3.800 | 37.233 | 155.00 | 37.233 | 155.00 |
| TM2250 | 3.800 | 37.233 | 155.00 | 37.233 | 155.00 |
| Lansco CB | 5.000 | 0.072 | 0.30 | 0.072 | 0.30 |
| R974 | 2.650 | 1.441 | 6.00 | 1.441 | 6.00 |
| Part B | | | | | |
| Epikure 3251 | 0.950 | 12.469 | 100.00 | 0.000 | 0.00 |
| Priamine 1074 | 0.910 | 0.000 | 0.00 | 12.469 | 100.00 |
| UTWFA240 | 3.800 | 43.641 | 350.00 | 43.641 | 350.00 |
| R974 | 2.650 | 0.249 | 2.00 | 0.249 | 2.00 |
| TM2250 | 3.800 | 43.641 | 350.00 | 43.641 | 350.00 |

| Property/Adhesion Property | | |
|---|---|---|
| Cure Condition: | 85° C., 30 min. | 85° C., 30 min. |
| T-peel strength | 1.4 | 3.0 |
| (lbf/in): | | |
| Lap Shear | 200 | 399 |
| Strength (psi): | | |
| Elongation To | 0.11 | 2.2 |
| Break (%): | | |

Further modification of the Part A was investigated. Flexibilizers having a high epoxy equivalent weight (EEW) and low viscosity were investigated, in addition to a self-assembling PEO-PBO block copolymer toughening agent for epoxy resins to ensure maintenance of the dispensing rate. Toughening agents having a molecular weight (MW) on the order of 3,000-5,000 g/mol or higher were excluded from the study due to their deleterious influence on the viscosity (resistance to flow) and resultant reduction in dispensing rate. This data shows that Heloxy 505, or a castor oil polyglycidyl ether flexibilizer provides a 707.1% improvement in T-peel strength when used in combination with the C₃₆-dimer fatty acid diamine curing agent. This improvement is greater than that provided by the PEO-PBO di-block copolymer toughening agent, which can improve the fracture toughness of neat epoxy resins significantly at low loading levels (5 phr or ˜5 wt % in a non-filled system). This may be due to the influence of the high Al₂O₃ concentration on the self-assembly and phase separation of the block copolymer prior to and during cure, respectively.

An investigation of incorporating a commercial PEO-PBO block copolymer, a tri-functional epoxy flexibilizer, and GLYMO to improve the T-peel strength properties of the thermally conductive interface material on a 6061 aluminum substrate is described in Table 2.

TABLE 2

| | Density | Example #3 | | Example #4 | | Example #5 | |
|---|---|---|---|---|---|---|---|
| Ingredient | (g/ml) | wt. % | phr | wt. % | phr | wt. % | phr |
| Part A | | | | | | | |
| EPON 862 | 1.180 | 11.410 | 47.50 | 9.008 | 37.50 | 6.659 | 35.00 |
| EPON 826 | 1.160 | 11.410 | 47.50 | 9.008 | 37.50 | 6.659 | 35.00 |
| Fortegra 100 | 1.030 | 1.201 | 5.00 | 0.000 | 0.00 | 0.000 | 0.00 |
| Heloxy 505 | 1.020 | 0.000 | 0.00 | 6.005 | 25.00 | 4.756 | 25.00 |
| Heloxy 62 | 1.080 | 0.000 | 0.00 | 0.000 | 0.00 | 0.000 | 0.00 |
| Silquest A-187 | 0.980 | 0.000 | 0.00 | 0.000 | 0.00 | 0.951 | 5.00 |
| (GLYMO) | | | | | | | |
| Cardolite 513 | 0.970 | 0.000 | 0.00 | 0.000 | 0.00 | 0.000 | 0.00 |
| TLT 100LV | 1.000 | 0.000 | 0.00 | 0.000 | 0.00 | 0.000 | 0.00 |
| UTWFA240 | 3.800 | 37.233 | 155.00 | 37.233 | 155.00 | 39.888 | 209.67 |
| TM2250 | 3.800 | 37.233 | 155.00 | 37.233 | 155.00 | 39.888 | 209.67 |
| Lansco CB | 5.000 | 0.072 | 0.30 | 0.072 | 0.30 | 0.057 | 0.30 |
| R974 | 2.650 | 1.441 | 6.00 | 1.441 | 6.00 | 1.141 | 6.00 |
| Part B | | | | | | | |
| Epikure 3251 | 0.950 | 0.000 | 0.00 | 0.000 | 0.00 | 0.000 | 0.00 |
| Priamine 1074 | 0.910 | 12.469 | 100.00 | 12.469 | 100.00 | 12.469 | 100.00 |
| UTWFA240 | 3.800 | 43.641 | 350.00 | 43.641 | 350.00 | 43.641 | 350.00 |
| R974 | 2.650 | 0.249 | 2.00 | 0.249 | 2.00 | 0.249 | 2.00 |
| TM2250 | 3.800 | 43.641 | 350.00 | 43.641 | 350.00 | 43.641 | 350.00 |

| Property/Adhesion Property | | | |
|---|---|---|---|
| Cure Condition: | 85° C., 60 min. | 85° C., 60 min. | 85° C., 60 min. |
| T-peel | 3.9 | 11.3 | 8.7 |
| strength (lbf/in): | | | |
| Lap Shear | 883 | 765 | 470 |
| Strength (psi): | | | |
| Elongation To | 1.4 | 6.3 | 7.5 |
| Break (%): | | | |

Further investigation of flexibilizers in the A-side is shown in Table 3. These results indicate that incorporation of both the PEO-PBO di-block copolymer and the castor oil polyglycidyl ether flexibilizer into the A-side composition, along with the modification of the B-side as shown in Example 2, leads to a further improvement in T-peel strength (+742.9%). However, the improvement was less than ‘additive’ and thus no synergy between the flexibilizer and self-assembling block copolymer was observed. Surprisingly, incorporation of the monofunctional epoxy diluent led to an improvement in the consistency in the lap shear strength vs. time after gelation, which may be due to the reaction of the monofunctional diluent and any unreacted secondary (2′) and tertiary (3′)amines to form the corresponding 3′ and even quaternary amines, as well as the reaction with —OH groups on the epoxy backbone.

TABLE 3

| | Density | Example #6 | | Example #7 | | Example #8 | | Example #9 | |
|---|---|---|---|---|---|---|---|---|---|
| Ingredient | (g/ml) | wt. % | phr | wt. % | phr | wt. % | phr | wt. % | phr |
| Part A | | | | | | | | | |
| EPON 862 | 1.180 | 6.659 | 35.00 | 9.008 | 35.00 | 9.008 | 37.50 | 5.432 | 27.50 |
| EPON 826 | 1.160 | 6.659 | 35.00 | 9.008 | 35.00 | 9.008 | 37.50 | 5.432 | 27.50 |
| Fortegra | 1.030 | 0.951 | 5.00 | 0.000 | 0.00 | 0.000 | 0.00 | 0.000 | 0.00 |
| 100 | | | | | | | | | |
| Heloxy 505 | 1.020 | 4.756 | 25.00 | 0.000 | 0.00 | 0.000 | 0.00 | 4.938 | 25.00 |
| Heloxy 62 | 1.080 | 0.000 | 0.00 | 0.000 | 0.00 | 0.000 | 0.00 | 3.950 | 20.00 |
| Silquest | 0.980 | 0.000 | 0.00 | 0.000 | 0.00 | 0.000 | 0.00 | 0.000 | 0.00 |
| A-187 | | | | | | | | | |
| (GLYMO) | | | | | | | | | |
| Cardolite | 0.970 | 0.000 | 0.00 | 6.005 | 25.00 | 0.000 | 0.00 | 0.000 | 0.00 |
| 513 | | | | | | | | | |
| TLT 100LV | 1.000 | 0.000 | 0.00 | 0.000 | 0.00 | 6.005 | 25.00 | 0.000 | 0.00 |
| UTWFA240 | 3.800 | 39.888 | 209.67 | 37.233 | 209.67 | 37.233 | 155.00 | 39.502 | 200.00 |
| TM2250 | 3.800 | 39.888 | 209.67 | 37.233 | 209.67 | 37.233 | 155.00 | 39.502 | 200.00 |
| Lansco CB | 5.000 | 0.057 | 0.30 | 0.072 | 0.30 | 0.072 | 0.30 | 0.059 | 0.30 |
| R974 | 2.650 | 1.141 | 6.00 | 1.441 | 6.00 | 1.441 | 6.00 | 1.185 | 6.00 |
| Part B | | | | | | | | | |
| Epikure | 0.950 | 0.000 | 0.00 | 0.000 | 0.00 | 0.000 | 0.00 | 0.00 | 0.00 |
| 3251 | | | | | | | | | |
| Priamine | 0.910 | 12.469 | 100.00 | 12.469 | 100.00 | 12.469 | 100.00 | 14.245 | 100.00 |
| 1074 | | | | | | | | | |
| UTWFA240 | 3.800 | 43.641 | 350.00 | 43.641 | 350.00 | 43.641 | 350.00 | 42.735 | 300.00 |
| R974 | 2.650 | 0.249 | 2.00 | 0.249 | 2.00 | 0.249 | 2.00 | 0.285 | 2.00 |
| TM2250 | 3.800 | 43.641 | 350.00 | 43.641 | 350.00 | 43.641 | 350.00 | 42.735 | 300.00 |

| Property/Adhesion Property | | | | |
|---|---|---|---|---|
| Cure | | | | |
| Condition: | 85° C., 60 min. | 85° C., 60 min. | 85° C., 60 min. | 85° C., 60 min. |
| T-peel | 11.8 | 11.2 | 8.7 | 6.1 |
| strength | | | | |
| (lbf/in): | | | | |
| Lap Shear | 678 | 724 | 667 | 555 |
| Strength | | | | |
| (psi): | | | | |
| Elongation | 8.5 | 7.2 | 1.7 | 8.1 |
| To Break | | | | |
| (%): | | | | |
| Thermal | | | | 2.0 |
| Conductivity | | | | |
| (ASTM | | | | |
| D5470), | | | | |
| W/m*K | | | | |

The mode-I fracture toughness, or the strain energy release rate, GIc of Comparative Example 1 and Example 9 were determined via tapered double cantilever beam (TDCB) testing completed on the basis of ISO/FDIS 25217. The GIc of Comparative Example 1 was 179.6 J/m², while the GIc of Example 9 was 536.6 J/m², corresponding to a 198.8% increase in fracture toughness, or resistance to crack propagation. Thus, traditional carboxyl-terminated butadiene-acrylonitrile copolymer and polyurethane pre-polymeric toughening agents are not required for significant improvements in mode-I fracture properties of highly filled thermal interface material compositions based on epoxy resins. The mode-I fracture toughness of a conventional polyurethane-based thermal interface material was determined to be 778.2 J/m². Although polyurethane-based thermal interface materials often show superior fracture toughness vs epoxy thermal interface materials, the composition of Example 9 shows a 79.8% higher tensile modulus vs. the conventional polyurethane-based thermal interface material. Thus, the composition described in Example 9 provides good shear modulus, tensile elongation (>8%), thermal conductivity and a fracture toughness approaching the conventional polyurethane-based thermal interface material, along with an 80.9% improvement in dispensing rate. The viscosity of the two-part composition of Example 9 are 290 Pas for Part A and 167 Pa*s for Part B at 25° C. and at a shear rate of 1 s⁻¹.

The results in Table 4 below show a significant improvement in thermal reliability properties of Example 9 vs. Comparative Example 1. This may be due to improved durable adhesion resulting from an improvement in uncured adhesive wetting, along with increased strain-to-failure to improve interfacial adhesion.

TABLE 4

| Example | t = 0 hr | t = 250 hr | t = 500 hr | t = 750 hr | t = 1000 hr |
|---|---|---|---|---|---|
| Comparative | 0.929 ± | 0.929 ± | 1.192 ± | 1.246 ± | 1.269 ± |
| Example 1 | 0.162 | 0.294 | 0.349 | 0.401 | 0.290 |
| (° C./W) | | | | | |
| Example 9 | 0.605 ± | 0.623 ± | 0.561 ± | 0.561 ± | 0.657 ± |
| (° C./W) | 0.027 | 0.057 | 0.020 | 0.029 | 0.025 |

That which is claimed is:

1. A two-part curable composition for forming a thermally conductive interface material, the composition comprising:
a first part including an epoxy resin component having first epoxy resin and a second epoxy resin that is different from the first epoxy resin, wherein the second epoxy resin has an epoxy equivalent weight of at least 100, the epoxy resin component having a viscosity of no more than 5000 cP at 25° C. and at a shear rate of 1 s⁻¹;
a second part including an amine component having an amine curing agent effective to cure the first and second epoxy resins, wherein the amine curing agent has an amine hydrogen equivalent weight of at least 80 g/eq, and the amine component has a viscosity of no more than 5000 cP at 25° C. and at a shear rate of 1 s⁻¹; and
thermally conductive filler in at least one of the first and second parts, wherein the cured thermally conductive interface material exhibits a thermal conductivity of at least 1.0 W/m*K.

2. The two-part curable composition as in claim 1 wherein the thermally conductive interface exhibits a t-peel strength of at least 5 lb_{f}/in, a tensile elongation to break of at least 5%, and a lap shear strength of at least 350 psi.

3. The two-part curable composition as in claim 1, including between 50-95% by weight of the thermally conductive filler in each of the first and second parts of the two-part composition.

4. The two-part curable composition as in claim 2 wherein the epoxy resin component includes between 2-15% by weight of the first epoxy resin, and between 2-8% by weight of the second epoxy resin.

5. The two-part curable composition as in claim 1 wherein the epoxy resin component includes a monofunctional epoxy resin that is different from the first and second epoxy resins.

6. The two-part curable composition as in claim 4 wherein the second epoxy resin includes a tri-functional epoxy resin.

7. The two-part curable composition as in claim 1 wherein the thermally conductive filler is selected from boron nitride, aluminum nitride, alumina, alumina trihydrate, silicon, silicon carbide, graphite, diamond, magnesium oxide, magnesium hydroxide, zinc oxide, and combinations thereof.

8. The two-part curable composition as in claim 4 wherein the thermally conductive filler includes aluminum oxide.

9. The two-part curable composition as in claim 1 wherein the curing agent includes a branched or unbranched alkane chain having at least 20 carbon atoms.

10. The two-part curable composition as in claim 8 wherein the alkane chain of the curing agent includes at least 30 carbon atoms.

11. The two-part curable composition as in claim 1 wherein the epoxy equivalent weight of the second epoxy resin is at least 250.

12. A two-part curable composition for forming a thermally conductive interface material, the composition comprising:
a first part including an epoxy resin component having a first epoxy resin and a second monofunctional epoxy resin that is different from the first epoxy resin, the epoxy resin component having a viscosity of no more than 5000 cP at 25° C. and at a shear rate of 1 s⁻¹;
a second part including an amine component having an amine curing agent effective to cure at least the first epoxy resin, the amine component having a viscosity of no more than 5000 cP at 25° C. and at a shear rate of 1 s⁻¹; and
thermally conductive filler in at least one of the first and second parts, wherein the cured thermally conductive interface material exhibits a thermal conductivity of at least 1.0 W/m*K.

13. The two-part curable composition as in claim 11 wherein the first epoxy resin is multifunctional.

14. The two-part curable composition as in claim 11, including a third epoxy resin that is different from each of the first and second epoxy resins, wherein the third epoxy resin is curable by the amine curing agent.

15. The two-part curable composition as in claim 13 wherein the epoxy resin component includes between 1% and 10% by weight of the first epoxy resin, between 1% and 10% by weight of the second epoxy resin, and between 1% and 30% by weight of the third epoxy resin.

16. The two-part curable composition as in claim 11 wherein at least one of the first and second parts includes between 50% and 95% by weight of the thermally conductive filler.

17. The two-part curable composition as in claim 15 wherein the thermally conductive filler is selected from particles of boron nitride, aluminum nitride, alumina, alumina trihydrate, silicon, silicon carbide, graphite, diamond, magnesium oxide, magnesium hydroxide, zinc oxide, and combinations thereof.

18. The two-part curable composition as in claim 11 wherein the monofunctional second epoxy resin includes an oxygen atom at a beta position.

19. The two-part curable composition as in claim 11 wherein the amine curing agent is free from an ether group.

20. A battery system, comprising:
a battery cell;
a heat dissipater; and
a thermally conductive interface material disposed between the battery cell and the heat dissipater along a thermal dissipation pathway, the thermally conductive interface material being curably formed from a two-part curable composition including:
(i) a first part having a first epoxy resin having an epoxy equivalent weight of at least 250, and a second monofunctional epoxy resin that is different from the first epoxy resin;
(ii) a second part having an amine curing agent effective to cure at least the first epoxy resin; and
(iii) thermally conductive filler in at least one of the first and second parts in an amount sufficient so that the thermally conductive interface material exhibits a thermal conductivity along the thermal dissipation pathway of at least 1.0 W/m*K.

21. The battery system as in claim 19 wherein the mixed two-part curable composition exhibits a viscosity of no more than 500,000 cP at 25° C. and at a shear rate of 1 s⁻¹.
